(19) United States
(12) Patent Application Publication
(10) Pub. No.: US 2009/0186130 A1
(43) Pub. Date: Jul. 23, 2009

(54) Aquatic Feed

(76) Inventor: Clem Lewis Butler, Fleckney (GB)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 12/356,380

(22) Filed: Jan. 20, 2009

(30) Foreign Application Priority Data
Jan. 22, 2008 (GB) 0801103.3

(51) Int. Cl. A23K 1/00

(52) U.S. Cl. 426/96

(57) ABSTRACT

An article of aquatic animal feed is provided comprising a predetermined quantity of one or more aquatic animal foodstuffs enclosed within a water-soluble capsule. The capsule forms a barrier around said foodstuff during storage and dissolves when placed in water to allow dispersal of the foodstuff therefrom in use.

### TECHNICAL FIELD

The present invention relates to aquatic feed and more specifically, although not exclusively, to fish food.

The present invention is particularly intended for ornamental fish, such as cold water, tropical or marine fish which are kept in a tank, although it will be appreciated that the present invention is not limited solely to the feeding of ornamental fish in tanks and may be adopted for alternative aquatic animals and environments.

### BACKGROUND OF THE INVENTION

Conventional food for ornamental fish, takes the form of powdered or flaked foodstuffs which is sprinkled by a user onto the water surface. A user will typically pinch an amount of foodstuff using their fingers as a rough estimate of the quantity of feed required. Whilst a measuring device such as a scoop or spoon may be used, there exists a significant likelihood of either over or under feeding of the fish.

In addition, repeatedly touching or otherwise exposing foodstuffs to the atmosphere can contaminate the foodstuff.

This problem is exacerbated when one considers that dietary requirements and methods of feeding can vary significantly between different types of fish. Any number of types of fish may be present in a single tank and may require foodstuffs to be present at any or any combination of the water surface, suspended mid-tank or else at the floor of the tank. In addition, there are different types of food required for carnivores and various non-carnivorous fish such as algae feeders.

Such variations in feeding requirements may result in a user maintaining multiple types of feed, each of which must be stored independently and levels of which must be monitored to ensure that each individual foodstuff does not run out. Many such foodstuffs also have an unpleasant odour, which can deter individuals from correct handling and measurement of the feed.

It is an object of the present invention to provide aquatic animal feed in a form which is straightforward to administer. It is a further object of the present invention to provide aquatic feed in a form which reduces the likelihood of contamination.

### SUMMARY

According to the present invention there is provided aquatic animal feed comprising a water soluble capsule enclosing a predetermined quantity of one or more aquatic animal foodstuffs.

The provision of known quantities of feed within a water soluble capsule is particularly advantageous since a user can feed fish simply by placing one or more capsules into the water without the need to measure suitable volumes of foodstuff or else touch the foodstuff directly.

An important distinction be drawn between capsules which are used for pharmaceutical preparations or food supplements for land animals, which are intended to be swallowed by the animal, and encapsulated foodstuffs according to the present invention, for which the capsule is intended to dissolve prior to feeding so as to release the foodstuffs into the animal's environment.

In one embodiment, the capsule may comprise a plurality of foodstuffs in predetermined quantities. The individual foodstuffs within the capsule may be of different types and have differing densities. One or more foodstuffs may have a density greater than that of water such that it sinks upon dispersal in water, whilst one or more other foodstuffs may have a lesser density such that it floats or else remains suspended in water upon dispersal from the capsule.

The one or more foodstuffs may be inserted into the capsule in such a manner as to create a capsule which floats of sinks dependent on the type of aquatic animal to be fed. The volume of air and feed and/or the density of the feed within the capsule may be controlled accordingly.

The present invention is typically supplied in the form of a retail article comprising a container, within which a plurality of capsules are enclosed. The number of capsules within the container may be predetermined so as to represent sufficient feed for a predetermined number of aquatic animals over a predetermined period of time. For example, each capsule may be suitable for one day's feed for one fish of a known type such that each container contains a number of capsules which equates to that number of days food.

The present invention has been found to provide an unexpected advantage in that, as the capsule dissolves, the foodstuff disclosed therein either sinks or floats, thereby creating a pleasing visual effect which encourages a user to watch the fish being fed. This has the benefit that user's tend to monitor the feeding habits of their fish more closely.

### BRIEF DESCRIPTION OF DRAWINGS

Further preferable features of the present invention are defined within the dependent claims. One or more embodiments of the present invention are described below with reference to the accompanying drawings, of which:

FIG. 1 shows an exploded view of an aquatic animal feed capsule according to the present invention; and,

FIG. 2 shows a plurality of capsules once formed housed in a container.

### DETAILED DESCRIPTION OF THE DRAWINGS

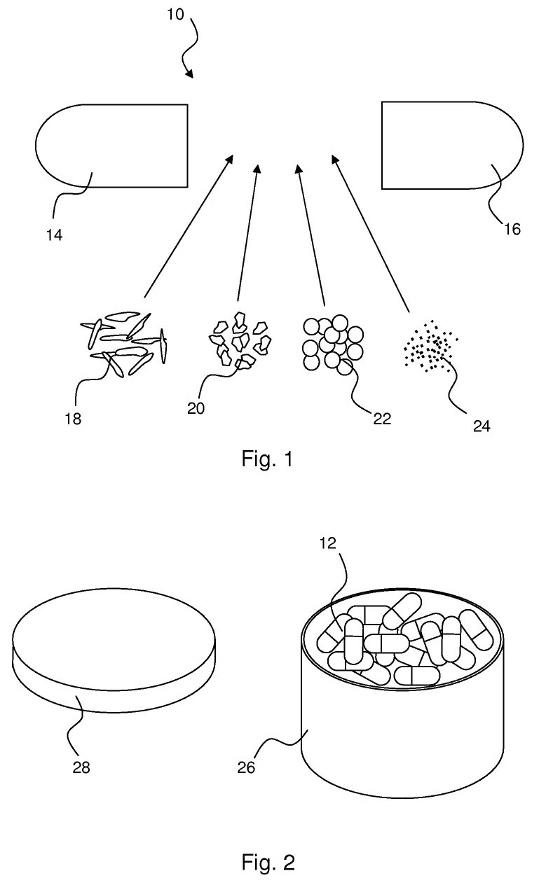

Turning firstly to FIG. 1, there is shown generally at 10 an aquatic animal feed article according to the present invention. The article 10 generally comprises a capsule 12 having opposing partial capsule sections 14 and 16. Each capsule section is in the shape of an open ended container portion which is generally cylindrical in shape, having a rounded end. The diameter of the capsule section 14 is slightly smaller than the diameter of the capsule section 16 such that the open end of section 14 can be inserted into the open end of section 16 in the direction of arrow A to form the capsule 12 which capable of completely enclosing any foodstuffs contained therein.

The capsule sections 14 and 16 are formed of a material which is water soluble. The capsule 12 in this embodiment is of a type typically referred to as a hard-shelled capsule. The capsule sections comprise a plant-based gelling agent such as a carrageenan or a modified form of starch and/or cellulose. In one embodiment, the gelling agent comprises hypromellose.

The gelling agent further comprises an amount of water such that the capsule sections are sufficiently solid in dry ambient conditions that they retain their shape. In this state the capsules behave in a manner similar to that of a plastic. The capsule sections may additionally comprise a plasticising material.

In a further embodiment, the capsule sections may comprise gelatine derived from animals. Such a capsule additionally comprises an amount of water in order to achieve the desired solidity in ambient conditions. A gelatine based capsule will also typically comprise a plasticising material such as glycerine, sorbitol or the like, which may also be used in conjunction with the plant-based gelling agent described above.

The capsule sections described above are typically formed by dipping a suitable shaped die or mould into a liquid bath of the capsule material. When removed from the bath, the skin of capsule material is dried and removed from the die to form the capsule section.

In either embodiment, the capsule sections may also comprise a preservative and/or a colouring or opacifying agent. However in a preferred embodiment, the capsule sections will avoid unnecessary additives since they may remain in solution once the capsule has dissolved and be harmful to aquatic animals.

The size of the capsule once formed may vary according to the amount of foodstuffs it is desired to hold. Typical capsule sizes may vary from 1 cm to 3 cm in length and 0.10 to approximately 1.4 ml in internal volume. Such sizes may be equivalent to standard capsule sizes used for other purposes which vary from size 5 to size 000. In one embodiment, a standard two-part size 1 vegetarian capsule has been found to be suitable although any capsule having an internal volume in the region of 1 ml would suffice.

It will be appreciated that larger capsules having an internal volume of between 1.4 and 3 ml may also be provided dependent on the size and number of aquatic animals to be fed.

Various different food types may be encapsulated within the capsule 12. Such foodstuffs are typically measured and inserted into capsule section 14 prior to formation of the complete capsule 12. As shown in FIG. 1, foodstuffs for insertion into the capsule may be provided in the form of flakes 18, granules 20, pellets 22 or smaller granules such as powders 24. One capsule may comprise a single or a plurality of such forms of foodstuff. The pellets may comprise a compressed mass of foodstuff, such as for example a bead or ball. Other types of foodstuff may be compressed or aerated as required to achieved the desired density.

It will be appreciated that the density of such different forms of foodstuffs varies and so the weight of the capsule once filled may be varied to suit certain requirements. That is to say that the weight of the capsule may be tailored to create a capsule which either sinks or floats when placed in water. It may be desirous to provide a capsule that floats such that a user can easily see whether the capsule has dissolved correctly. In one embodiment, foodstuff of relatively low density such as flaked foodstuffs may be pressed or compressed into the capsule so as to increase the density of the filled capsule. Such compressed foodstuff may advantageously be dispersed more slowly than uncompressed foodstuff once the capsule has dissolved.

Furthermore once the capsule has dissolved, the different types of foodstuff may either sink or float or be generally buoyant underwater dependent on its density.

Typical foodstuffs for insertion into the capsules may be similar or the same as the makeup of conventional feed for aquatic animals and will not be described in detail here since such foodstuffs will be well known to the skilled person and can vary significantly dependent on the dietary requirements of the animals in question.

Each food stuff is measured by weighing or else by volume prior to insertion into the capsule such that capsules of the same type are generally consistent in terms of the weight and/or volume of the ingredients. In one embodiment, the measuring is achieved simply by filling the capsule to its maximum capacity.

By way of example only, the ingredients of one particular capsule type intended for cold water fish may comprise measured amounts of mixed freeze-dried blood worm, daphnia, pellets and flake. Capsules for ornamental tropical fish may comprise high protein granules, daphnia, catfish pellets and flake. Capsules for marine fish may comprise freeze-dried blood worm, brine shrimp, daphnia and flake.

A typical analysis of the capsule contents may be a make up of 40-60% protein, 10-20% oil, 1-4% fibre and the remainder being made up of ash. In one embodiment the foodstuff comprises 50% protein, 16% oil, 1.5% fibre and 32.5% ash.

The capsule, which may be a two-part size 1 vegetarian capsule, will dissolve completely in temperatures between 24 and 28° Centigrade thus dispersing the food which contains flake, granules and sinking pellets. In cold water conditions the capsule will completely or at least partially dissolve so as to release the foodstuff therein. A user may choose to remove partially dissolved capsules as necessary.

Turning now to FIG. 2, there is shown a container 26 and lid 28 for containing a plurality of capsules 12 according to the present invention. The combined container and capsules may be provided in the form of a retail article. The container may have user indicia, ingredients and/or feeding instructions printed or otherwise provided thereon.

Containers may be provided having loose capsules therein. Each capsule may represent one day's worth of feed and capsules may be provided in the container in multiples of thirty capsules so as to represent multiples of approximately a months supply of feed.

In one embodiment, the capsules may be provided in shaped containers having compartments for a predetermined number of capsules so as to represent daily, weekly or other predetermined feeding cycles.

In such an embodiment, the compartments may be provided by way of a blister pack, in which multiple compartments are provided in the form of a tray, over which is provided a frangible layer of material, such as a foil or the like. The compartments may be ordered in an array having a number of rows and/or columns so as to represent a number of feeding increments, such as a number of feeds per day or week. Printed indicia may be provided on the frangible layer representative of the feeding increments, such as times of the day, days of a week, week in a month or the like.

This form of packaging may be particularly advantageous since it can serve to remind a user when the last feed was given and/or when the next feed is due by virtue of the last compartment for which the seal is broken. Such indications may also serve as a timeline for the user to remind the user about other routine acts which need to be performed such as cleaning of the tank or other apparatus, changing of the water or the like.

Whilst the above described embodiment relate to two-part capsules it will be appreciated that other capsule types are available such a single part capsules which may be formed about the foodstuff, which may be hard-shelled or soft-shelled in accordance with known capsule forming techniques.

In either embodiment, a distinction can be drawn between capsules which provide a casing or skin about the foodstuffs contained therein according to the present invention and pelletised type foodstuffs which take the form of a generally solid agglomerated mass. The present invention offers significant advantages over a simple agglomerated mass of foodstuff and binder material since the outer casing provides a protective layer around the foodstuff and can dissolve rapidly and consistently with little or no residue.

1. An article of aquatic animal feed comprising a predetermined quantity of one or more aquatic animal foodstuffs enclosed within a water-soluble capsule, wherein said capsule forms a barrier around said foodstuff during storage and wherein said capsule dissolves when placed in water to allow dispersal of the foodstuff therefrom in use.

2. An article of aquatic animal feed according to claim 1, wherein said capsule is a hollow casing, the foodstuff being enclosed within said casing.

3. An article of aquatic animal feed according to claim 1, wherein said capsule comprises a gelling agent.

4. An article of aquatic animal feed according to claim 3, wherein said gelling agent is a plant based material.

5. An article of aquatic animal feed according to claim 3, wherein said gelling agent comprises a starch or cellulose based material.

6. An article of aquatic animal feed according to claim 3, wherein said gelling agent comprises gelatine.

7. An article of aquatic animal feed according to claim 1, wherein said capsule comprises a plasticising component.

8. An article of aquatic feed according to claim 1, wherein said foodstuff comprises an or any combination of flaked, granulated or pelleted material.

9. An article of aquatic animal feed according to claim 1, wherein said capsule comprises a foodstuff having a density greater than that of water.

10. An article of aquatic animal feed according to claim 1, wherein said capsule comprises a foodstuff having a density less than that of water.

11. An article of aquatic animal feed according to claim 1, wherein said capsule contains two or more foodstuffs, each said foodstuff having a different density.

12. An article of aquatic animal feed according to claim 1, wherein said capsule, and it contents, have a combined density greater than that of water such that said capsule sinks during use.

13. An article of aquatic animal feed according to claim 12, wherein at least some of said foodstuff within said capsule has a density less than water such that said at least some foodstuff rises from said capsule as it dissolves during use.

14. An article of aquatic animal feed according to claim 1, wherein said capsule, and it contents, have a combined density less than that of water such that said capsule is buoyant during use.

15. An article of aquatic animal feed according to claim 14, wherein at least some of said foodstuff within said capsule has a density greater than water such that said at least some foodstuff sinks from said capsule as it dissolves during use.

16. An article of aquatic animal feed according to claim 1, wherein said capsule has an internal volume of less than 3 ml.

17. An article of aquatic animal feed according claim 1, wherein said capsule contains sufficient foodstuffs to feed one fish for one day.

18. A retail article of aquatic animal feed comprising a container in which is contained a predetermined number of articles according to claim 1, said predetermined number of articles relating to a predetermined number of days feed for one or more aquatic animals.
